(19) United States
(12) Patent Application Publication
(10) Pub. No.: US 2021/0080792 A1
(43) Pub. Date: Mar. 18, 2021

(54) ELECTRO-OPTIC ELEMENT ELECTRICAL CONNECTIONS

(71) Applicant: GENTEX CORPORATION, Zeeland, MI (US)

(72) Inventors: Adam R. Heintzelman, Grand Rapids, MI (US); Juan C. Lara, Holland, MI (US); Christopher M. Derry, Allegan, MI (US); David J. Cammenga, Zeeland, MI (US)

(73) Assignee: GENTEX CORPORATION, Zeeland, MI (US)

(21) Appl. No.: 17/021,365

(22) Filed: Sep. 15, 2020

Related U.S. Application Data
(60) Provisional application No. 62/901,111, filed on Sep. 16, 2019.

(51) Int. Cl. G02F 1/155; G02F 1/161

(52) U.S. Cl. CPC G02F 1/155; G02F 1/161

(57) ABSTRACT

An electro-optic element having a groove is disclosed herein. The electro-optic element may include first and second substrates, first and second electrodes, an electro-optic medium, and first and second electrical buses. The first substrate may have a first surface, a second surface, and a first peripheral edge. The second substrate may be substantially parallel to the first substrate and have a third surface, a fourth surface, and a second peripheral edge. The groove is defined by a first and/or second substantially flat groove surfaces. The first groove extends between the second surface and the first peripheral edge or the first surface at a non-orthogonal angle. The second groove surface extends between the third surface and the second peripheral edge or the fourth surface at a non-orthogonal angle. The first and second electrical buses are disposed in the groove and are electrically connected to the first and second electrodes, respectively.

### CROSS-REFERENCE TO RELATED APPLICATIONS

This application claims priority under 35 U.S.C. § 119(e) to U.S. Provisional Application No. 62/901,111 filed on Sep. 16, 2019, entitled “ELECTRICAL CONNECTIONS FOR ELECTRO-OPTIC ELEMENTS,” the disclosure of which is hereby incorporated by reference in its entirety.

### FIELD OF INVENTION

The present disclosure generally relates to electro-optic elements and, more particularly, to electrical connections for electro-optic elements.

### BACKGROUND OF INVENTION

Electro-optic devices are well known and becoming increasingly common, particularly in vehicles. Very thin electro-optic devices, such as those used for heads-up displays, however, present a problem with electrical potential delivery across the electrodes. Specifically, as the cell spacing decreases, there is decreasing space for bus bars, which deliver the electrical potential to the electrodes. This reduction in cell spacing causes the bus bars to necessarily be thinner when they are disposed between substrates. Thinner bus bars of the same width and length present the problem of substantially increased electrical resistance. To overcome this problem, the edges of the substrates of the electro-optic device, in some instances, may be modified to create a stepped channel. The electrode materials may accordingly be disposed over the stepped channel. The increase in space by the stepped channel allows for increased bus bar size, for a given electro-optic device, and the electrode materials disposed over the stepped channel allow for electrical communication between the electrodes and the bus bars. However, extreme angles created by the stepped edge do not lend well to sputtering, the process commonly used for deposing the electrode materials onto the substrates, and accordingly may result in poor electrical connections between the bus bars and the electrodes. Accordingly, there is a need for improved electro-optic devices with small cell spacings.

### SUMMARY

According to one aspect of the present disclosure, an electro-optic element may include a first substrate, a second substrate, a first electrode, a second electrode, an electro-optic medium, a groove, a first electrical bus, and a second electrical bus. The electro-optic element may be part of a heads-up display for a vehicle. The first substrate may be substantially transparent may and have a first surface, a second surface, and a first peripheral edge. The second substrate may be substantially parallel to the first substrate and have a third surface, a fourth surface, and a second peripheral edge. The first electrode may be associated with the second surface. Similarly, the second electrode may be associated with the third surface. The electro-optic medium may be disposed between the first electrode and the second electrode. Further, the electro-optic medium may be electrochromic. The groove may be defined by a first groove surface and a second groove surface. The first groove surface is substantially flat and extends between the second surface and the first peripheral edge or the first surface at a non-orthogonal angle. In some embodiments, the first electrode may also be associated with the first groove surface. The second groove surface is also substantially flat and extends between the third surface and the second peripheral edge or the fourth surface at a non-orthogonal angle. In some embodiments, the first electrode may also be associated with the first groove surface. The first and second groove surfaces may extend at an acute, obtuse, or a right angle relative one another. The first electrical bus is disposed, at least in part, in the groove. The first electrical bus may further be associated with the first groove surface. Additionally, the first electrical bus is electrically connected to the first electrode. Likewise, the second electrical bus is disposed, at least in part, in the groove. Additionally, the second electrical bus may be electrically connected to the second electrode. The second electrical bus is similarly electrically connected to the second electrode. In some embodiments, the groove may substantially contain each of the first and the second electrical busses along its entirety. In other embodiments, the first electrical bus may be disposed in a first portion of the groove and the second electrical bus may be disposed in a second portion of the groove. The second portion may be different and exclusive of the first portion. In some embodiments, the first and/or second electrical busses may be constructed of a conductive spring.

The electro-optic element may further include a protective polymer. The protective polymer may encapsulate the groove. Further, the protective polymer may extend, at least in part, onto the first and/or second surfaces.

The electro-optic element may further include one or more conductive member. The conductive member may be electrically connected to the first electrical bus. Further, the conductive member may wrap around the first peripheral edge and extend onto the first surface. Alternatively, the conducive member may wrap around the second peripheral edge and extend onto the second surface. In some embodiments, the conductive member may be coupled to the first or second electrical bus via a conductive tape. Additionally, the conductive member may be in electrical communication with a contact pad disposed, at least in part, on the first or second surface.

According to another aspect of the present disclosure, an electro-optic element may include a first substrate, a second substrate, a first electrode, a second electrode, an electro-optic medium, a groove, a first electrical bus, and a second electrical bus. The electro-optic element may be part of a heads-up display for a vehicle. The first substrate may be substantially transparent and may have a first surface, a second surface, and a first peripheral edge. The second substrate may be substantially parallel to the first substrate and have a third surface, a fourth surface, and a second peripheral edge. The first electrode may be associated with the second surface. Similarly, the second electrode may be associated with the third surface. The electro-optic medium may be disposed between the first electrode and the second electrode. Further, the electro-optic medium may be electrochromic. The groove may be defined by one or more of a first groove surface and a second groove surface. The first groove surface is substantially flat and extends between the second surface and the first peripheral edge or the first surface at a non-orthogonal angle. In some embodiments, the first electrode may also be associated with the first groove surface. The second groove surface is also substantially flat and extends between the third surface and the second peripheral edge or the fourth surface at a non-orthogonal angle. In some embodiments, the first electrode may also be associated with the first groove surface. The first electrical bus is disposed, at least in part, in the groove. The first electrical bus may further be associated with the first groove surface. Additionally, the first electrical bus is electrically connected to the first electrode. Likewise, the second electrical bus is disposed, at least in part, in the groove. Additionally, the second electrical bus may be electrically connected to the second electrode. The second electrical bus is similarly electrically connected to the second electrode. In some embodiments, the groove may substantially contain each of the first and the second electrical busses along its entirety. In other embodiments, the first electrical bus may be disposed in a first portion of the groove and the second electrical bus may be disposed in a second portion of the groove. The second portion may be different and exclusive of the first portion. In some embodiments, the first and/or second electrical busses may be constructed of a conductive spring.

The electro-optic element may further include a protective polymer. The protective polymer may encapsulate the groove. Further, the protective polymer may extend, at least in part, onto the first and/or second surfaces.

The electro-optic element may further include one or more conductive member. The conductive member may be electrically connected to the first electrical bus. Further, the conductive member may wrap around the first peripheral edge and extend onto the first surface. Alternatively, the conducive member may wrap around the second peripheral edge and extend onto the second surface. In some embodiments, the conductive member may be coupled to the first or second electrical bus via a conductive tape. Additionally, the conductive member may be in electrical communication with a contact pad disposed, at least in part, on the first or second surface.

The advantages of certain embodiments of the present disclosure include the presence of the groove in the electro-optic element. The groove may allow for increased bus bar size relative a size that would otherwise be physically allowable for a given cell spacing of an electro-optic element. Accordingly, increased cross-sectional area of the first and/or second bus bars may be obtained. This is particularly advantageous for electro-optic elements having a small cell spacing. The increased cross-sectional area provides the advantage of decreasing the resistivity of the first and/or second bus bars. A further advantage of the groove is that the sloped first and/or second groove surfaces may allow for superior application of the first and/or second electrodes thereto via sputtering. Steep edges, such as those created by right angles, like in a stepped configuration, can result in un-coated or unsatisfactorily coated portions, and thus compromise electrical connections. Additionally, in embodiments where one or more of the first and second bus bars are conductive springs, the first and second bus bars may have the advantage of maintaining a sufficient electrical contact with the first and/or second electrode, due to the conductive spring's elastic properties.

These and other aspects, objects, and features of the present invention will be understood and appreciated by those skilled in the art upon studying the following specification, claims, and appended drawings. It will also be understood that features of each embodiment disclosed herein may be used in conjunction with, or as a replacement for, features in other embodiments.

### BRIEF DESCRIPTION OF FIGURES

In the drawings:

FIG. 1: Schematic representation of a vehicle having an electro-optic element.

FIG. 2: Schematic representation of an electro-optic element.

FIG. 3: Cross-sectional schematic representation of an embodiment of an electro-optic element.

FIG. 4: Cross-sectional schematic representation of an embodiment of an electro-optic element.

FIG. 5: Cross-sectional schematic representation of an embodiment of an electro-optic element.

FIG. 6: Cross-sectional schematic representation of an embodiment of an electro-optic element.

FIG. 7: Cross-sectional schematic representation of an embodiment of an electro-optic element.

FIG. 8: Cross-sectional schematic representation of an embodiment of an electro-optic element.

FIG. 9: Cross-sectional schematic representation of an embodiment of an electro-optic element.

FIG. 10: Cross-sectional schematic representation of an embodiment of an electro-optic element.

### DETAILED DESCRIPTION

For the purposes of description herein, the specific devices and processes illustrated in the attached drawings and described in this disclosure are simply exemplary embodiments of the inventive concepts defined in the appended claims. Hence, specific dimensions and other physical characteristics relating the embodiments disclosed herein are not limiting, unless the claims expressly state otherwise.

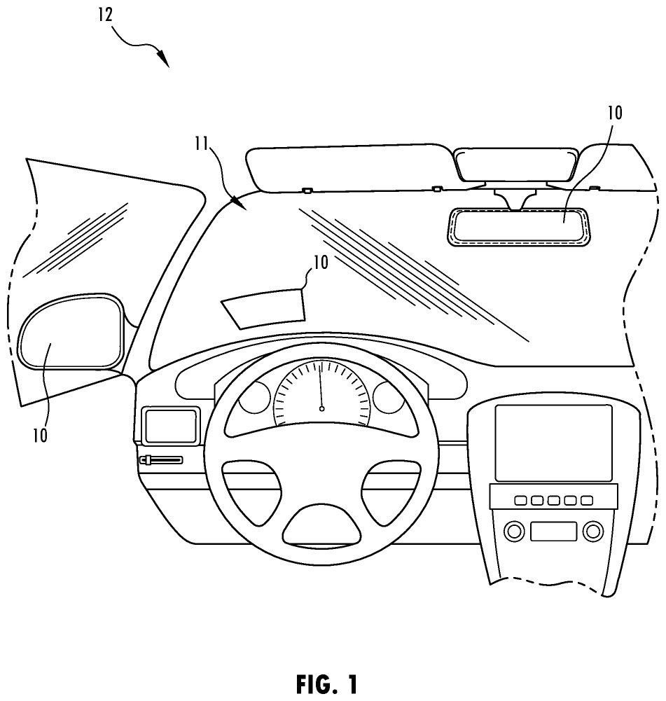

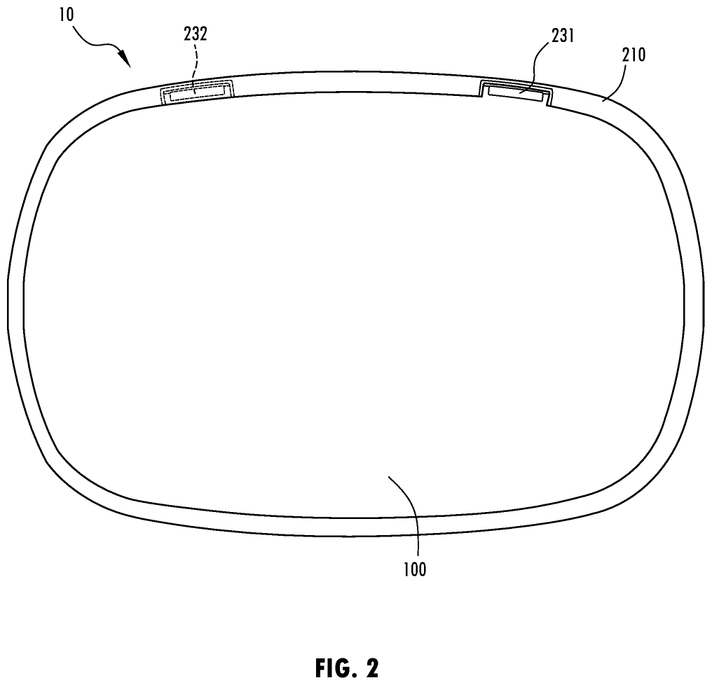

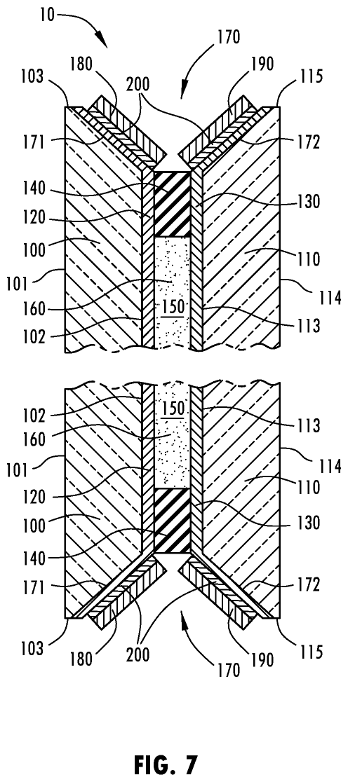

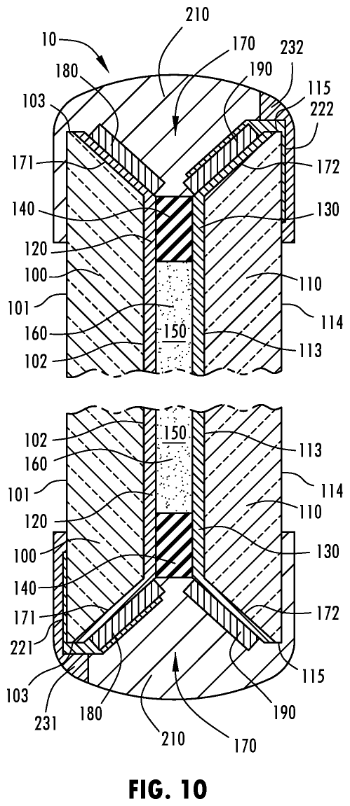

FIGS. 1-10 are schematic representations of an electro-optic element 10. Electro-optic element 10, for example, may be a window, rear-view assembly, or a heads-up display. Further, in some embodiments, electro-optic element 10 may be a high current draw device, such as an electrochromic device, opposed to a field affect device or a low current draw device, such as a liquid crystal device. Accordingly, electro-optic element 10 may require one or more electrical bus bars. A high current draw device may have a current draw of greater than or equal to 10 mA/m² for a duration greater than 1 second. In embodiments where electro-optic element 10 is a heads-up display, electro-optic element 10 may be affixed to or laminated with a windshield 11 of a vehicle 12 or a standalone device mounted to or attached to a dashboard or console of vehicle 12. In some further embodiments, the heads-up display may correspond to a pop-up display that may be selectively extended or retracted from the dashboard of vehicle 12. Electro-optic element 10 may be variably transmissive. In embodiments where electro-optic element 10 is a heads-up display, an image maybe displayed on electro-optic element 10, accordingly, reducing the transmittance of electro-optic element 10 may enhance contrast and thus enhance the visibility of the image. Further, electro-optic element 10 may comprise one or more of: a first substrate 100, a second substrate 110, a first electrode 120, a second electrode 130, a seal 140, a chamber 150, an electro-optic medium 160, a groove 170, a first electrical bus 180, and a second electrical bus 190.

First substrate 100 comprises a first surface 101, a second surface 102, and a first peripheral edge 103. Further, first substrate 100, may be fabricated from any of a number of materials that are transparent or substantially transparent in the visible region of the electromagnetic spectrum, such as borosilicate glass, soda lime glass, float glass, natural and synthetic polymeric resins, plastics, and/or composites. Substrate materials may be selected from any number of materials so long as the materials are substantially transparent and exhibit appropriate physical properties such as strength and tolerance to conditions of the electro-optic element's 10 environment, such as ultra-violet light exposure from the sun and temperature extremes.

Second substrate 110 is disposed in a substantially parallel, spaced apart relationship relative first substrate 100. The spacing (i.e. the cell spacing) between first substrate 100 and second substrate 110 may be less than or equal to about 100 μm, 90 μm, 75 μm, 50 μm, 40 μm, 35 μm, or 20 μm. Further, second substrate 110 comprises a third surface 113, a fourth surface 114, and a second peripheral edge 115. Additionally, second substrate 110 may be fabricated from the same or similar materials as that of first substrate 100. However, if electro-optic element 10 is a mirror, then the requisite of substantial transparency is not necessary. Accordingly, second substrate 110 may alternatively be opaque and, as such, may comprise polymers, metals, glass, and ceramics.

First electrode 120 is an electrically conductive material associated with second surface 102. The electrically conductive material of first electrode 120 may be substantially transparent in the visible region of the electromagnetic spectrum and generally resistant to corrosion from materials contained within electro-optic element 10. The electrically conductive material may be a transparent conductive oxide (TCO), such as fluorine doped tin oxide (FTO), indium-doped oxide, doped zinc oxide, or other materials known in the art. Further, first electrode 120 may have a sheet resistance of between about 1 ohms/sq. and about 100 ohms/sq. For example, the sheet resistance may be less than about 10 ohms/sq., 6 ohms/sq., or 3 ohms/sq. Similarly, second electrode 130 is an is an electrically conductive material associated with third surface 113. In some embodiments, second electrode 130 may likewise be substantially transparent. Accordingly, the electrically conductive material of second electrode 130 may be fabricated from the same or similar materials as that of first electrode 120. Such a construction may be adopted when electro-optic element 10 is a window or a heads-up display. In other embodiments, the requisite of substantial transparency is not necessary. In some embodiments, second electrode 130 may be reflective or comprise a reflective layer. In other embodiments, a reflector may be associated with second electrode 130, with third surface 113 between second electrode 130 and second substrate 110, or with fourth surface 114 of second substrate 110. Typical reflective materials include chromium, rhodium, ruthenium, silver, aluminum, gold, platinum, palladium, nickel, molybdenum, and combinations thereof. Further, second electrode 130 may have a sheet resistance of between about 1 ohms/sq. and about 100 ohms/sq. For example, the sheet resistance may be less than about 10 ohms/sq., 6 ohms/sq., or 3 ohms/sq.

Seal 140 may be disposed in a peripheral manner to define a chamber 150 between first substrate 100 and second substrate 110. Chamber 150 may be defined by seal 140 in conjunction with at least two of: first substrate 100, second substrate 110, first electrode 120, and second electrode 130. In some embodiments, chamber 150 may, more specifically, be defined by seal 140, first electrode 120, and second electrode 130. Seal 140 may comprise any material capable of being adhesively bonded to the at least two of: first substrate 100, second substrate 110, first electrode 120, and second electrode 130, to in turn seal chamber 150 such that electro-optic medium 160 does not inadvertently leak out.

Electro-optic medium 160 is disposed in chamber 150. Electro-optic medium 160 is electro-active. Therefore, electro-optic medium 160 is operable between activated and un-activated states in response to an electrical potential. Accordingly, electro-optic medium 160 may include, among other materials, electro-active anodic and cathodic materials. In some embodiments, the anodic and/or cathodic materials may be electrochromic. In other words, the electro-optic medium 160 may be electrochromic. Electrochromic means that upon activation, due to the application of an electronic voltage or potential, the electrochromic item may exhibit a change in absorbance at one or more wavelengths of the electromagnetic spectrum. Accordingly, the electro-optic medium 160 may be variably transmissive. The change in absorbance may be in the visible, ultra-violet, infra-red, and/or near infra-red regions. In other embodiments, electro-optic medium 160 may be a liquid crystal medium or a suspended particle medium. Electro-optic medium 160 may be fabricated from any one of a number of materials, including, for example, those disclosed in U.S. Pat. No. 6,433,914, entitled “Color-Stabilized Electrochromic Devices,” which is herein incorporated by reference in its entirety.

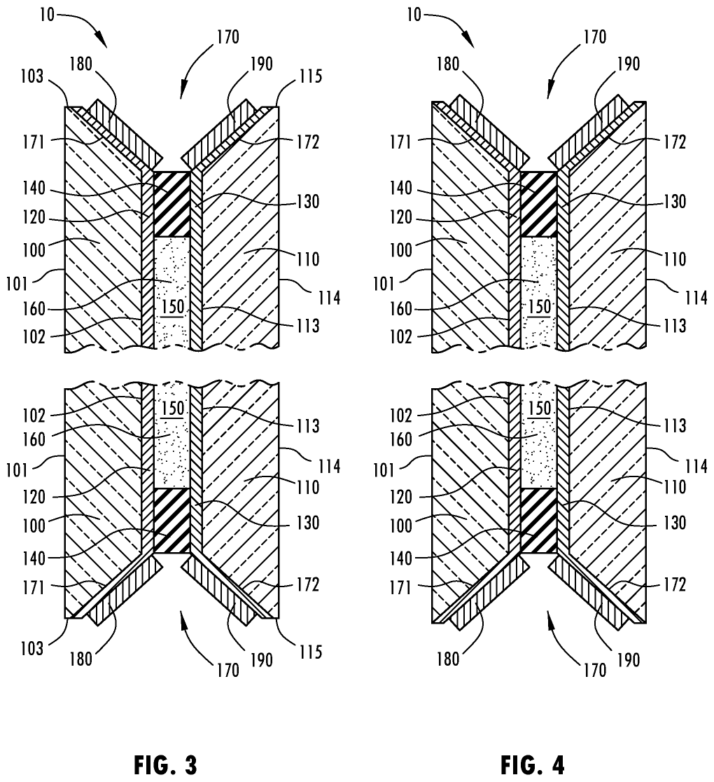

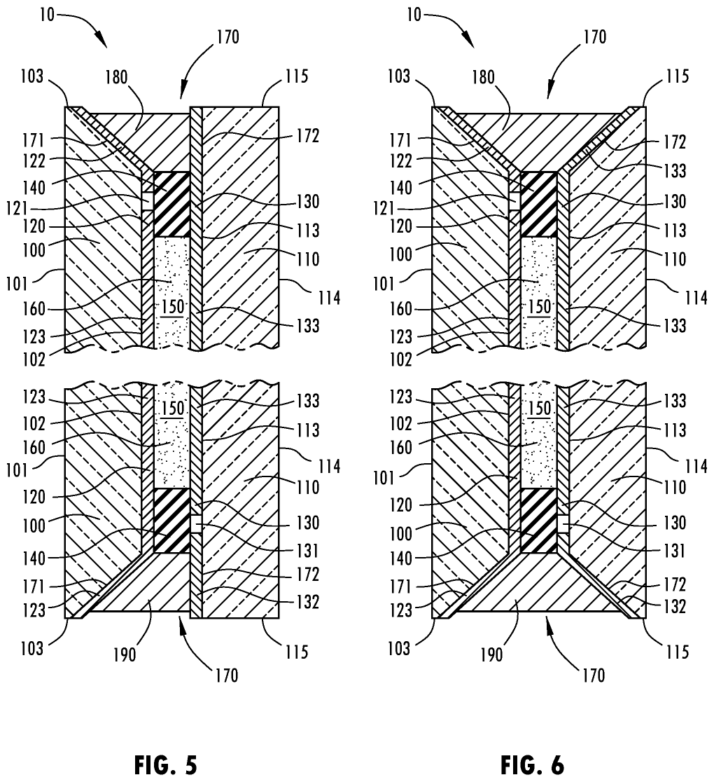

Groove 170 may be defined by a first groove surface 171 and/or a second groove surface 172. First groove surface 171 may be substantially or completely flat and extend between second surface 102 and first peripheral edge 103 (as shown in FIGS. 3 and 5-10) or first surface 101 (as shown in FIG. 4), at a non-orthogonal angle. Accordingly, first groove surface 171 may be planar or substantially planar. In other words, groove 170 may be defined, at least in part, by a beveled edge of first substrate 100. In some embodiments, first groove surface 171, may extend at an angle between 95 and 175 degrees relative second surface 102. Second groove surface 172 may be substantially or completely flat and extend between third surface 113 and second peripheral edge 115 (as shown in FIGS. 3 and 5-10) or fourth surface 114 (as shown in FIG. 4), at a non-orthogonal angle. Accordingly, second groove surface 172 may be planar or substantially planar. In other words, groove 170 may be defined, at least in part, by a beveled edge of second substrate 110. In some embodiments, second groove surface 172, may extend at an angle between 95 and 175 degrees relative third surface 113. Therefore groove 170 may be V shaped. Relative one another, the first and second groove surfaces 171, 172 may be at an acute, an obtuse, or a right angle. Additionally, groove 170 may be continuous about the peripheries of the first and second substrates 110, 120 or may be discontinuous about the peripheries of the first and second substrates 110, 120. In some embodiments, groove 170 may be defined by only one beveled first or second substrate 100, 110 (as shown in FIG. 5). Accordingly, in some embodiments, groove 170 may be defined by second or third surface 102, 113 and second or first groove surface 172, 170, respectively.

First electrical bus 180 may be disposed fully or partially in groove 170. Accordingly, first electrical bus 180 may be disposed, completely or at least in part, between first surface 101 and fourth surface 114. In some embodiments, first electrical bus 180 may be associated with first groove surface 171. First electrical bus 180 is electrically conductive. Further, first electrical bus 180 may have an electrical conductivity that is substantially greater than the electrical conductivity of first electrode 120. For example, first electrical bus 180 may be formed from an electrically conductive material, such as, conductive ink, conductive solder, a conductive spring, a conductive epoxy (e.g., silver epoxy), a wire, conductive tape, a conductive carbon material, or combinations thereof.

Second electrical bus 190 may likewise be disposed fully or partially in groove 170 and may be comprised of the same or similar materials as first electrical bus 180. Accordingly, second electrical bus 190 is electrically conductive. Further, first electrical bus 190 may have an electrical conductivity that is substantially greater than the electrical conductivity of second electrode 130. In some embodiments, second electrical bus 180 may be associated with second groove surface 172.

The first and second electrical busses 180, 190 may be electrically isolated one another. In some embodiments, the first and second electrical busses 180, 190 may be separated by an electrical insulator. Each of the first and second electrical busses 180, 190 may fully fill or partially fill a cross-section of groove 170 where the cross-section is substantially orthogonal to and bisects the first and second substrates 100, 110.

In some embodiments, the first and second electrical busses 180, 190 may each substantially extend along the peripheries of the first and second substrates 100, 110 (as shown in FIGS. 3-4 and 7-10). In other words, a cross-section of groove 170 may contain both the first and second electrical busses 180, 190. The cross-sectional may be substantially orthogonal to and bisect the first and fourth surfaces 101, 114. In other embodiments, first electrical bus 180 may extend along and be limited to a first portion of the peripheries of the first and/or second substrates 100, 110, and second electrical bus 190 may similarly extend along and be limited to a second portion of the peripheries of the first and/or second substrates 100, 110 (as shown in FIGS. 5-6), where first and second portions are different. In other words, groove 170 may have a first cross-sectional portion and a second cross-sectional portion where first cross-sectional portion contains first electrical bus 180 and second cross-sectional portion contains second electrical bus 190. The cross-sectional portions may be substantially orthogonal to and bisect the first and fourth surfaces 101, 114.

In some embodiments, groove 170 may substantially extend along half or more, three quarters or more, or the entireties of the peripheries of the first and second substrates 100, 110. The first and second electrical busses 180, 190 taken together may be substantially disposed in the entirety or in only part of the extent of groove 170. Accordingly, the first and second electrical busses 180, 190 taken together may substantially extend along half or more, three quarters or more, or the entireties of the peripheries of the first and second substrates 100, 110.

First electrical bus 180 may be electrically connected to first electrode 120. In some embodiments, the electrical connection may be facilitated by an extension of first electrode 120 onto first groove surface 171. Similarly, second electrical bus 190 may be electrically connected to second electrode 130. In some embodiments, the electrical connection may be facilitated by an extension of second electrode 130 onto second groove surface 172. The extensions of the first and/or second electrodes 120, 130 onto the first and/or second groove surfaces 171, 172, respectively, may be of a continuous composition of the substantial entirety of each respective electrode. Alternatively, the electrodes may transition to an alternative conductive material at the extensions. For example, the electrodes may transition to a chrome material. The transition may be in a continuously electrically conductive fashion. In some embodiments, the first and/or second electrodes 120, 130 may extend only partially on the first and/or second groove surfaces 171, 172, respectively. In other embodiments, the first and/or second electrodes 120, 130 may extend all the way to the first and/or second peripheral edges 103, 115, respectively, completely covering the first and/or second groove surfaces 171, 172, respectively. In some further embodiments, the first and/or second electrodes 120, 130 may extend onto the first and/or second peripheral edges 103, 115, respectively. Additionally, the first and/or second electrodes 120, 130 may even wrap around the first and/or second peripheral edges 103, 115 and onto the first and/or fourth surfaces 101, 114, respectively.

The first and/or second electrical busses 180, 190 may be coupled to or associated with the first and/or second groove surfaces 171, 172 and/or first and second electrical connectors 221, 222 with a conductive tape 200 that has a conductive adhesive, such as a Z-conductive tape. In embodiments where the first and/or second electrodes 120, 130 extend onto the first and/or second groove surfaces 171, 172, the conductive tape may be electrically coupled to the first and/or second electrodes 120, 130, respectively. A metal layer of the conductive tape 200 may be positioned over the conductive adhesive layer such that the conductive adhesive layer is located in between the metal layer and the first and/or second electrodes 120, 130. In some embodiments, the metal layer of the conductive tape 200 may include a copper foil, which may be tin plated.

In some embodiments, first electrode 120 and second electrode 130 may each define first and second isolation areas 121, 131, respectively (as shown in FIG. 5-6). The first and second isolation areas 121, 131 may correspond to ablation lines. First isolation area 121 may serve to electrically isolate a first region 122 of first electrode 120 from a second region 123 of first electrode 120. Second region 123 may comprise the portion of first electrode 120 extending onto first groove surface 171 and in electrical communication with first electrical bus 180. Second isolation area 131 may serve to electrically isolate a third region 132 of second electrode 130 from a fourth region 133 of second electrode 130. Fourth region 133 may comprise the portion of second electrode 130 extending onto second groove surface 171 and in electrical communication with second electrical bus 190. The first and second isolation areas 121, 131 may align with seal 140. The first and third regions 122, 132 may correspond, at least in part, to an area of electro-optic element 10 aligned with chamber 150. To prevent shorting of the electrical circuit, the electrical isolation of the first and third regions 122, 132 from the second and fourth regions 123, 133, respectively, may be beneficial in embodiments where first bus 180 makes electrical contact with second region 123 and/or second bus 190 makes electrical contact with fourth region 133.

In some embodiments, electro-optic element 10 may further comprise a protective encapsulant 210. Protective encapsulant 210 may encapsulate, cover, or otherwise seal groove 170. Accordingly, protective encapsulant 210 may extend onto first surface 101 and/or fourth surface 114. Further, protective encapsulant 210 may be formed from a polymeric material, such as an elastomer, and may be generally water and shock resistant.

In some embodiments, the first electrical bus 180 and/or the second electrical bus 190 may be conductive springs (as shown in FIG. 9). The conductive springs may be composed of a material that yields satisfactory conductivity. Additionally, the material may also enable the spring to retaining it's elastic “springlike” qualities. In some further embodiments, the conductive springs may be press fit into channels of protective encapsulant 210. In some yet further embodiments, the conductive springs may be stretched in an encircling or arcuate manner such that, when put in place, the conductive springs' desire to contract exerts a force in the direction of the a respective first or second electrode 120, 130. Accordingly, the conductive spring may maintain an electrical contact between itself and the first or second electrode 120, 130.

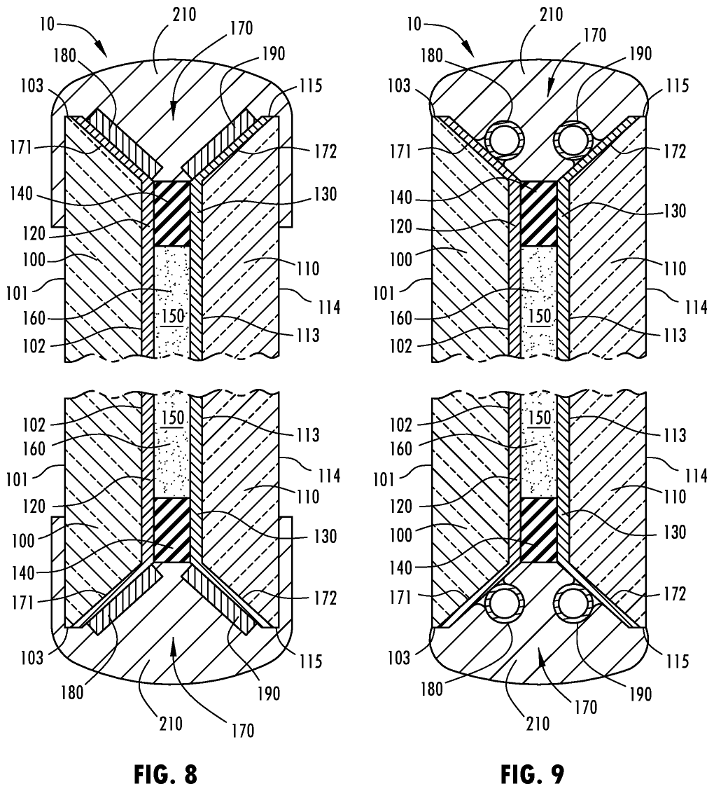

In some embodiments, electro-optic element 10 may further comprise a first electrical connector 221 and/or a second electrical connector 222 (as shown in FIGS. 8-10). The first and second electrical connectors 221, 222 may provide for an electrical connection with the first and second electrical busses 180, 190 and/or the first and second electrodes 120, 130, respectively. The first and second electrical connectors 221, 222, may each extend into groove 170. Additionally, the first and second electrical connectors 221, 222, may be coupled with the first and second electrical busses 180, 190 by a conductive adhesive. Further, the first and second electrical connectors 221, 222 may each, for example, be a J-clip. Additionally, a portion of each of the first and second electrical connectors 221, 222 may extend outside of protective encapsulant 200.

In some embodiments, electro-optic element 10 may further comprise a first and/or a second contact pad 231, 232. The first and/or second contact pads 231, 232 may make an electrical connection with the first and/or second electrical connectors 221, 222, respectively. Further, the first and second contact pads 231, 232 may be on the same or different sides of electro-optic element 10. For example, first contact pad 231 may couple with first substrate 100 and second contact pad 232 may couple with second substrate 110. Alternatively, the first and second contact pads 231, 232 may each be coupled with first substrate 100. Furthermore, the first and second contact pads 231, 232 may be proximate one another along a periphery of first substrate 100.

In operation, an electrical potential may be provided to the first and second busses 180, 190, which in turn may convey the electrical potential to the first and second electrodes 120, 130, respectively. The first and second electrodes 120, 130 may accordingly apply the electrical potential to electro-optic medium 160. Upon application of the electrical potential, electro-optic medium 160 may change to a substantially activated state, such as a state of reduced transmittance.

Some embodiments of the present disclosure have the advantage of groove 170. Groove 170 may allow for increased bus bar size relative a size that would otherwise be physically allowable for a given cell spacing of an electro-optic element 10. Accordingly, increased cross-sectional area of the first and/or second bus bars 180, 190, may be obtained. This is particularly advantageous for electro-optic elements 10 having a small cell spacing. The increased cross-sectional area provides the advantage of decreasing the resistivity of the first and/or second bus bars 180, 190. A further advantage of groove 170 is that the sloped first and second groove surfaces 171, 172 allow for superior application of the first and/or second electrodes 120, 130 thereto via sputtering. Steep edges, such as those created by right angles, like in a stepped configuration, can result in un-coated or unsatisfactorily coated portions, and thus compromise electrical connections. Additionally, in embodiments where one or more of the first and second bus bars 180, 190 are conductive springs, the first and second bus bars 180, 190 may have the advantage of maintaining a sufficient electrical contact with the first and/or second electrode 120, 130, due to the conductive spring's elastic properties.

In this document, relational terms, such as “first,” “second,” and the like, are used solely to distinguish one entity or action from another entity or action, without necessarily requiring or implying any actual such relationship or order between such entities or actions.

As used herein, the term “and/or,” when used in a list of two or more items, means that any one of the listed items can be employed by itself, or any combination of the two or more of the listed items can be employed. For example, if a composition is described as containing components A, B, and/or C, the composition can contain A alone; B alone; C alone; A and B in combination; A and C in combination; A and C in combination; B and C in combination; or A, B, and C in combination.

For purposes of this disclosure, the term “associated” generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The term “substantially,” and variations thereof, will be understood by persons of ordinary skill in the art as describing a feature that is equal or approximately equal to a value or description. For example, a “substantially planar” surface is intended to denote a surface that is planar or approximately planar. Moreover, “substantially” is intended to denote that two values are equal or approximately equal. If there are uses of the term which are not clear to persons of ordinary skill in the art, given the context in which it is used, “substantially” may denote values within about 10% of each other, such as within about 5% of each other, or within about 2% of each other.

It is to be understood that although several embodiments are described in the present disclosure, numerous variations, alterations, transformations, and modifications may be understood by one skilled in the art, and the present disclosure is intended to encompass these variations, alterations, transformations, and modifications as within the scope of the appended claims, unless their language expressly states otherwise.

What is claimed is:

1. An electro-optic element comprising:
a first substrate being substantially transparent and having a first surface, a second surface, and a first peripheral edge;
a second substrate substantially parallel the first substrate, the second substrate having a third surface, a fourth surface, and a second peripheral edge;
a first electrode associated with the second surface;
a second electrode associated with the third surface;
an electro-optic medium disposed between the first electrode and the second electrode;
a groove defined by a first groove surface and a second groove surface, the first groove surface being substantially flat and extending between the second surface and at least one of the first peripheral edge and the first surface at a non-orthogonal angle, the second groove surface being substantially flat and extending between the third surface and at least one of the second peripheral edge and the fourth surface at a non-orthogonal angle; and
a first electrical bus disposed, at least in part, in the groove, the first electrical bus electrically connected to the first electrode; and
a second electrical bus disposed, at least in part, in the groove, the second electrical bus electrically connected to the second electrode.

2. The electro-optic element of claim 1, further comprising a protective polymer encapsulating the groove.

3. The electro-optic element of claim 2, wherein the protective polymer extends onto the first and second surfaces.

4. The electro-optic element of claim 1, wherein the electro-optic medium is electrochromic.

5. The electro-optic element of claim 1, wherein:
the first electrode is also associated with the first groove surface; and
the second electrode is also associated with the second groove surface.

6. The electro-optic element of claim 1, wherein the first groove surface extends between the second surface and the first peripheral edge.

7. The electro-optic element of claim 1, wherein the second groove surface extends between the third surface and the second peripheral edge.

8. The electro-optic element of claim 1, wherein the electro-optic element is part of a heads up display for a vehicle.

9. The electro-optic element of claim 1, wherein the first groove surface and the second groove surface extend in an acute angle relative one another.

10. The electro-optic element of claim 1, wherein the first groove surface and the second groove surface extend in an obtuse angle relative one another.

11. The electro-optic element of claim 1, wherein the first groove surface and the second groove surface extend at a substantially right angle relative one another.

12. The electro-optic element of claim 1, further comprising a conductive member electrically connected to the first electrical bus, the conductive member wrapping around the first peripheral edge and extending onto the first surface.

13. The electro-optic element of claim 12, wherein the conductive member is coupled to the first electrical bus via a conductive adhesive.

14. The electro-optic element of claim 12, wherein the conductive member is in electrical communication with a contact pad disposed, at least in part, on the first surface.

15. The electro-optic element of claim 1, wherein the first electrical bus is associated with the first groove surface.

16. The electro-optic element of claim 1, wherein the second electrical bus is associated with the second groove surface.

17. The electro-optic element of claim 1, wherein the groove substantially contains each of the first and the second electrical busses along its entirety.

18. The electro-optic element of claim 1, wherein:
the first electrical bus is disposed in a first portion of the groove; and
the second electrical bus is disposed in a second portion of the groove, the second portion of the groove being different than the first portion.

19. The electro-optic element of claim 1, wherein the first and second electrical busses are springs.

20. An electro-optic element comprising:
a first substrate being substantially transparent and having a first surface, a second surface, and a first peripheral edge;
a second substrate substantially parallel the first substrate, the second substrate having a third surface, a fourth surface, and a second peripheral edge;
a first electrode associated with the second surface;
a second electrode associated with the third surface;
an electro-optic medium disposed between the first electrode and the second electrode;
a groove defined by at least one of a first groove surface and a second groove surface, the first groove surface being substantially flat and extending between the second surface and at least one of the first peripheral edge and the first surface at a non-orthogonal angle, the second groove surface being substantially flat and extending between the third surface and at least one of the second peripheral edge and the fourth surface at a non-orthogonal angle; and
a first electrical bus disposed, at least in part, in the groove, the first electrical bus electrically connected to the first electrode; and
a second electrical bus disposed, at least in part, in the groove, the second electrical bus electrically connected to the second electrode.
